(19) United States
(12) Patent Application Publication
(10) Pub. No.: US 2019/0321926 A1
(43) Pub. Date: Oct. 24, 2019

(54) PROCESS AND APPARATUS FOR APPLYING TORQUE

(71) Applicant: ESCO Group LLC (formerly ESCO Corporation), Portland, OR (US)

(72) Inventors: David M. Paul, Corbett, OR (US); Rodney K. Clarke, Cleveland (AU); Christopher M. Carpenter, Tualatin, OR (US)

(21) Appl. No.: 16/370,864

(22) Filed: Mar. 29, 2019

Related U.S. Application Data
(60) Provisional application No. 62/651,055, filed on Mar. 30, 2018.

(51) Int. Cl. B23P 19/06; E02F 9/28

(52) U.S. Cl. CPC B23P 19/06; E02F 9/2891

(57) ABSTRACT

A torque applying apparatus includes a hydraulically-driven power source that is adjustable for bi-directional rotation, an input portion configured to receive torque from a power source and having a first rotational axis, an output portion configured to provide torque to a rotating component and having a second rotational axis, and a force-multiplying mechanism connecting the input portion to the output portion. The second rotational axis is parallel to and laterally offset from the first rotational axis.

### FIELD OF THE INVENTION

The present invention pertains to a process and apparatus for applying torque.

### BACKGROUND OF THE INVENTION

In earth working operations, such as mining, ground-engaging wear parts are secured along the digging edge of a bucket of an excavating machine such as a dragline machine, cable shovel, face shovel, hydraulic excavator, and the like, to protect the digging edge from undue wear, break up the ground ahead of the digging edge and assist in gathering earthen material in the bucket. During use, the wear parts typically encounter heavy loading and highly abrasive conditions. As a result, they must be periodically replaced.

The wear part may comprise two or more components such as a base that is secured to the digging edge, and a wear member that mounts on the base to engage the ground. The wear member tends to wear out more quickly and is typically replaced a number of times before the base (which can also be a replaceable wear member) must also be repaired or replaced. One example of such a wear part is an excavating tooth. The tooth may be a two-part assembly that includes an adapter secured to the digging edge, and a point attached to the adapter to initiate contact with the ground. The tooth may also be a three-part assembly that includes a point secured to an intermediate adapter, which in turn, is secured to an adapter attached to the digging edge or to an integral nose of cast lip. Locks are used to secure the components together.

U.S. Pat. No. 9,222,243 discloses one example tooth that includes an adapter secured to the digging edge, an intermediate adapter mounted on the adapter, and a point mounted on the intermediate adapter. Locks are used to secure the point to the intermediate adapter, and the intermediate adapter to the adapter. In this example, one lock secures the point to the intermediate adapter, and two locks secure the intermediate adapter to the adapter. Each lock includes a collar that is fixed in a hole in the point or intermediate adapter, and a pin that is threaded in the collar for inward and outward adjustment between a hold position and a release position. In the hold position, the lock secures the point or intermediate adapter to its base. In the release position, the lock permits the point or intermediate adapter to be removed from and/or installed on the base.

### SUMMARY OF THE INVENTION

The present invention pertains to a process and apparatus for applying torque in an environment with limited clearance by, e.g., providing an offset torque, an enhanced torque and/or a reduced dimension at component engagement.

In one embodiment, a torque applying apparatus includes an input portion that receives torque from a power source, and an output portion that applies torque to a rotatable component. The axis of the applied torque is offset from and parallel to the axis of the received torque to ease the application of torque in environments with limited clearance. In one example, the thickness of the output portion is less than the thickness of the input portion with the power source. In one other example, the output portion of the apparatus has a smaller thickness than the input portion, particularly when combined with a power source. In another embodiment, the output portion has a thickness of about 60 mm. In another example, the thickness of the output portion can be about 25% of the combined thickness of the input portion and the power source. In another example, the torque applying apparatus enhances the torque such that the applied torque is greater than the received torque. In another example, the torque applying apparatus operates hydraulically. The features of these examples are usable in combination or separately.

In another embodiment, a process for turning a rotative member includes using a power source to generate torque and transferring the received torque to an offset and parallel applied torque where the output torque assembly is smaller than the input torque assembly. In this way torque application can be eased in environments of limited clearance. In one example, the torque is enhanced in the transfer such that the applied torque is greater than the received torque. In another example, the torque applying apparatus operates hydraulically. The features of these examples are usable in combination or separately.

In another embodiment, torque applying apparatus with torque enhancing capabilities may be linked in series to apply increased torque and/or maintaining the torque with smaller components. In one example, the torque applying apparatuses each provide an applied torque offset and parallel to a received torque, with the applied torque of the upstream apparatus being the received torque for the downstream apparatus. In one other example, the torque applying apparatuses are linked as mirror images with the initiating driving torque aligned with the final applied torque. In another example, the torque applying apparatuses are adjustably positioned relative to each other to accommodate different environments. The features of these examples are usable in combination or separately.

In another embodiment, a torque applying apparatus includes a hydraulically-driven power source that is adjustable for bi-directional rotation, an input portion configured to receive torque from a power source and having a first rotational axis, an output portion configured to provide torque to a rotating component and having a second rotational axis, and a force-multiplying mechanism connecting the input portion to the output portion. The second rotational axis is parallel to and laterally offset from the first rotational axis.

In another embodiment, a system for applying torque to a rotating component includes a power source and first and second torque applying apparatuses. Each of the torque applying apparatuses includes an input portion configured to receive torque and having a first rotational axis, an output portion configured to provide torque and having a second rotational axis, and a force-multiplying mechanism connecting the input portion to the output portion. The second rotational axis is parallel to and laterally offset from the first rotational axis. The power source is coupled to the input portion of the first torque applying apparatus, the output portion of the first torque applying apparatus is coupled to the input portion of the second torque applying apparatus, and the output portion of the second torque applying apparatus is coupled to the rotating component.

In another embodiment, a system for removing wear parts secured to earth working equipment by a rotating a locking element includes a gripper to hold the wear part secured to earth working equipment by a rotatable locking element, a power source, and a torque applying apparatus. The torque applying apparatus includes an input portion configured to receive torque from the power source and having a first rotational axis, an output portion configured to provide torque to the rotatable component and having a second rotational axis, and a force-multiplying mechanism connecting the input portion and the output portion. The second rotational axis is parallel to and laterally offset from the first rotational axis.

In another embodiment, a system for applying torque to a rotatable component accessible through a space of limited access includes a hydraulically-driven power source that is adjustable for bi-directional rotation and a torque applying apparatus. The torque applying apparatus includes an input portion configured to receive torque from the power source and having a first rotational axis, an output portion configured to provide torque to the rotatable component and having a second rotational axis, and a force-multiplying mechanism connecting the input portion and the output portion. The second rotational axis is parallel to and laterally offset from the first rotational axis.

In another embodiment, a process for removing wear parts secured to earth working equipment by a rotating a locking element includes holding the wear part secured to earth working equipment by a rotatable locking element with a gripper secured to a manipulator, coupling a torque applying apparatus to the rotatable locking element wherein the torque applying apparatus includes an input portion having a first rotational axis, an output portion having a second rotational axis that is parallel to and laterally offset from the first rotational axis, and a force-multiplying mechanism connecting the input portion and the output portion. Torque is supplied to the input portion to move the locking element to a release position, whereupon the wear part removed from the earth working equipment with the gripper and manipulator.

In another embodiment, a process for applying torque to a rotatable component accessible through a space of limited access includes using a torque applying apparatus including an input portion having a first rotational axis, an output portion having a second rotational axis that is parallel to and laterally offset from the first rotational axis, and a force-multiplying mechanism connecting the input portion and the output portion. The output portion is passed through the space of limited access and coupling the output portion to the rotatable component, torque is supplied to the input portion to rotate the rotatable component.

Processes and apparatus in accordance with embodiments of the invention may improve the replacement of worn ground-engaging wear parts especially when they are mounted on stepped lips. Such lips limit the available clearance to access locks for certain wear parts as compared to straight lips.

Processes and apparatus in accordance with embodiments of the invention may improve the removal of wear members from bases of certain earth working equipment by applying an offset torque to a separation tool. In example constructions, the torque may be enhanced and/or of reduced dimension at the tool.

Processes and apparatus in accordance with embodiments of the invention may improve the attachment and/or removal of blades from mold boards of certain earth working equipment by applying an offset torque to an appropriate tool. In example constructions, the torque may be enhanced and/or of reduced dimension at the tool.

Processes and apparatus in accordance with embodiments of the invention may improve the loosening of bolts in tight quarters and/or in locations that are difficult to access by applying an offset torque to an appropriate tool. In example constructions, the torque may be enhanced and/or of reduced dimension at the tool. Example applications may include bolts in conveyor systems, pipe connections, etc.; other applications are possible.

### BRIEF DESCRIPTION OF THE DRAWINGS

FIGS. 1A and 1B are each a perspective view of a torque tool including a torque head in accordance with the present invention.

FIG. 2 is a cross-sectional view of the torque head along a central plane perpendicular to the rotation axes of the input and output portions.

FIGS. 3a-3g are each a cross-sectional view along the same plane as FIG. 2 illustrating the sequence of operation of the torque head through one cycle.

FIG. 4 is a partial cross section along a plane parallel to the view in FIG. 2.

FIG. 5 is an exploded perspective view of the torque head.

FIG. 6 is a tool head including the torque head.

FIG. 7 is a perspective view of a sample tooth.

FIG. 8 is a partial plan view of a stepped lip.

FIG. 9 is a second tool head including the torque head.

FIG. 10 is a second embodiment of a torque applying apparatus.

FIG. 11 is a side view of the torque head operating to loosen the bolts securing a blade to a mold board.

FIG. 12 is a perspective view of a portion of a conveyor system.

FIG. 13 is a perspective view of a portion of another conveyor system.

FIG. 14 is a side view of the torque head operating to loosen the bolts securing two components together; one example are pipe flanges.

### DETAILED DESCRIPTION OF PREFERRED EMBODIMENTS

The present invention pertains to processes and apparatus for applying torque. Processes and apparatus in accordance with embodiments of the invention have application in a wide variety of environments requiring turning of a component accessible through an area of limited clearance. The rotative component could be threaded, simply rotated, or have another motion combined with rotation.

Processes and apparatus in accordance with the invention can have application in adjusting, tightening and/or releasing a lock for ground-engaging wear parts for earth working equipment where such is actuated by turning, threading and/or rotating a lock component to secure a wear part to mining equipment and/or install or release a wear part. One example includes wear parts secured to an excavating bucket.

The present invention also pertains to a process and apparatus for applying torque with a torque applying apparatus in accordance with the present invention, which may be useful in adjusting locks that secure wear parts on earth working equipment, but also have application in many other and diverse uses where an enhanced torque is desired or needed.

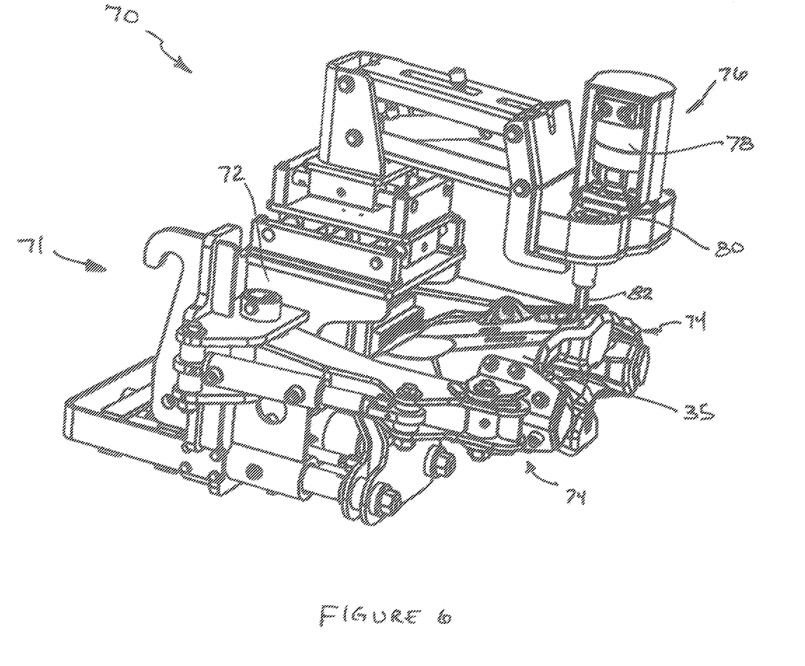

In a mining operation, a bucket may gather earthen material during digging. The bucket includes a shell that defines a cavity for gathering material. The bucket has a lip 25 that forms a digging edge. Teeth and shrouds are often secured to the lip to protect the digging edge, break up the ground ahead of the lip, and assist in gathering earthen material into the bucket. A plurality of teeth and shrouds, such as disclosed in U.S. Pat. No. 9,222,243, which is incorporated herein by reference in its entirety, are examples of such wear parts. Tooth 27 includes an adapter 31 welded to lip 25, an intermediate adapter 33 mounted on adapter 31, and a point 35 mounted on intermediate adapter 33 (FIG. 7). Point 35 includes a rearwardly-opening cavity to receive nose 37 of intermediate adapter 33, and a front end 39 to penetrate the ground. Likewise, intermediate adapter 33 includes a rearwardly-opening cavity to receive nose 43 of adapter 31. Locks 41 are used to secure point 35 to intermediate adapter 33, and intermediate adapter 33 to of adapter 31. One lock 41a is received in the top wall 42 of point 35, and a lock 41b, 41c is received in each sidewall 44 of intermediate adapter 33. Other tooth arrangements are possible.

Lock 41 includes a collar 46 with a threaded opening, and a threaded pin 50 received in the opening. Collar 46 is fixed in a hole such as hole 52a in point 35 and holes 52b in intermediate adapter 33. Collar 46 has a pair of lugs 54, 55 that are received in complementary slots (not shown) in each of the holes in a bayonet-type coupling. Once collar 46 is in place, a retainer 58 is inserted and snap-fit into a slot (not shown) in the hole to prevent movement of the collar in the hole. Pin 50 includes a head 60 with a socket 62 for receipt of a tool to turn pin 50 in collar 46. Rotation of the pin in one direction moves the pin inward and into contact with the nose 37, 43 received in the point 35 or intermediate adapter 33. Rotation in the opposite direction moves the pin outward and out of contact with the nose to permit installation and/or removal of the point or intermediate adapter. Substantial torque is needed at times to drive the pin in the release direction as fines can become impacted in and around the threads, the pin can become bent, the threads damaged, etc.

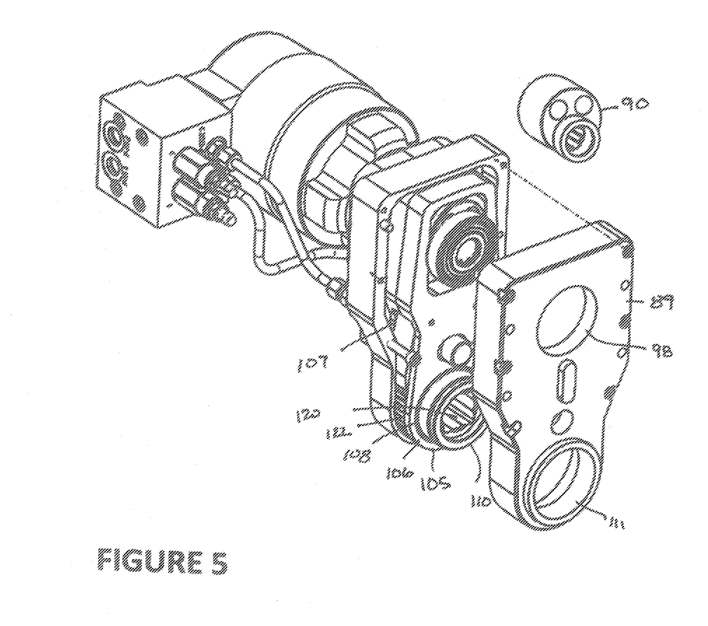

Systems have been developed to auto remove and/or install wear parts on earth working equipment such as disclosed in U.S. Patent Application 2015/0107075 and/or U.S. Patent Application 2017/0356167, which are each incorporated by reference herein in its entirety. In one embodiment, a tool head 70 connects to a manipulator (not shown) by connectors 71 (FIG. 6). A frame 72 supports a pair of gripping tools 74 and a torque tool 76. Torque tool 76 includes a motor 78, a torque applying apparatus 80 and a tool 82. The tool 82 engages socket 62 in pin 50 to adjust the pin between the hold and release positions. In one embodiment, motor 78 is a hydraulic motor but other motors could be used.

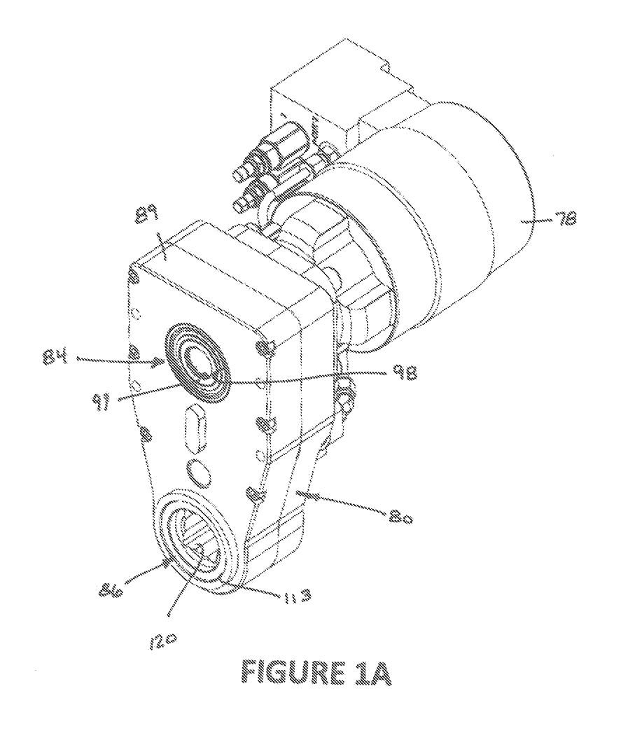

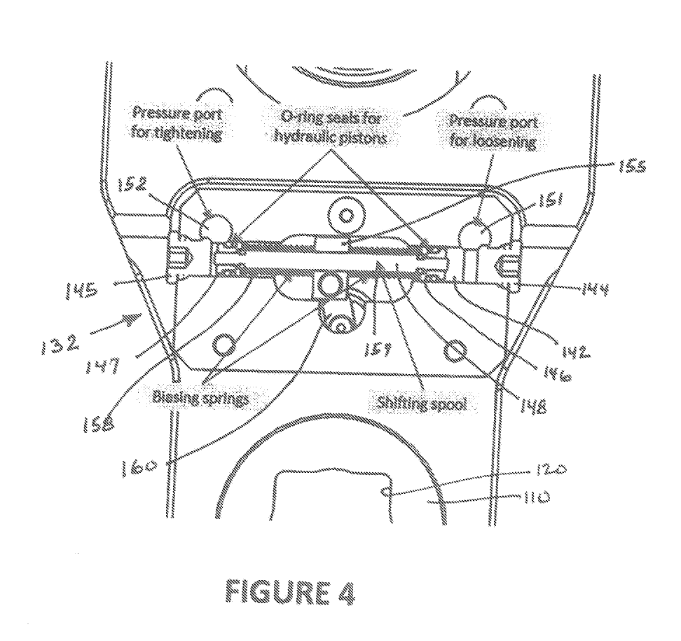

The torque applying apparatus or torque head 80 includes an input portion 84 to receive torque from a power source 78, and an output portion 86 that applies torque to a threaded or other rotating component such as pin 50 (FIGS. 1A-5). A rotating component as referred to herein includes components that turn about an axis regardless of how much they turn (e.g., they could turn more or less than a full turn) or whether they have other aspect to their movements (e.g., an axial motion while turning such as in a threaded component). The torque head 80 preferably is adjustable bi-directional rotation, i.e., it is capable of applying torque in either direction without removal from the assembly. In the present example, the torque head can drive pin 50 to the hold position or the release position. A driving mechanism 88 couples the input portion 84 to output portion 86 to transfer and enhance the torque such that the toque applied by the output portion is greater than the torque received by the input portion. The input portion 84, output portion 86 and driving mechanism 88 are contained within a housing 89.

Input portion 84 includes an eccentric 90 received within a bearing shoe 92. The bearing shoe has a cylindrical central opening 94 into which the eccentric 90 is received for rotatable motion. An eccentrically-positioned socket 95 is formed in eccentric 90 to receive the drive shaft 96 of motor 78 to provide torque about an axis A1. In one construction, drive shaft 96 is splined for complementary receipt into slots in socket 95, though other shapes are possible. A stem 97, concentric with and extending opposite the socket 96, is received in a corresponding hole 98 in the housing 89. Bushings 99 are preferably provided between stem 97 and the wall defining hole 98. With eccentric 90 anchored by stem 97, the eccentric swings about the drive shaft as the motor rotates the drive shaft. The bearing shoe 92 is received within a channel 101 defined in a torque arm 103 of driving mechanism 88. The torque arm extends between input portion 84 and output portion 86 with a proximal end 104 containing eccentric 90 and bearing shoe 92, and a distal end 105 defined as two spaced flanges 106, 107. Each flange 106, 107 defines a hole 108 to receive a ratchet wheel 110. The housing 89 also includes holes 111, 113 to receive opposite ends of the ratchet wheel 110 to anchor the ratchet wheel and limit movement of wheel 110 to a rotation about a fixed axis A2 offset and parallel to axis A1. Accordingly, rotation of drive shaft 96 causes eccentric 90 and bearing shoe 92 to orbit about the drive shaft. The bearing shoe 92 includes sidewalls 116, 117 that bear against side surfaces 118, 119 of channel 101, and slide toward and away from output portion 86 as the eccentric 90 and bearing shoe 92 orbit about drive shaft 96. The orbiting motion of bearing shoe 92 causes the proximal end 104 of torque arm 103 to oscillate laterally within housing 89 about ratchet wheel 110 of output portion 86. Ratchet wheel 110 includes an opening 120 to receive tool 82.

Ratchet wheel 110 includes a series of ridge-like teeth 122 around its perimeter and set between flanges 106, 107. A pair of pawls 124, 125 extend from the proximal end 104 of torque arm 103, on opposite sides, toward ratchet wheel 110. The pawls each have a series of teeth 127, 128 to selectively engage teeth 122 on wheel 110. As the torque arm 103 oscillates, it drives one of the pawls 124, 125 (depending on the direction of rotation) iteratively forward and into teeth 122 to incrementally turn ratchet wheel 110 with each forward motion. A stop 130 is provided to prevent reverse motion of the ratchet wheel when the pawl resets to make another forward push. In one example, the driving mechanism 88 enhances the force from the drive shaft 96 to the tool 82 (i.e., the force applied to pin 50 or other driven member) by about 12:1, though changes to size, shape, etc. of the driving assembly components could produce other levels of enhancement.

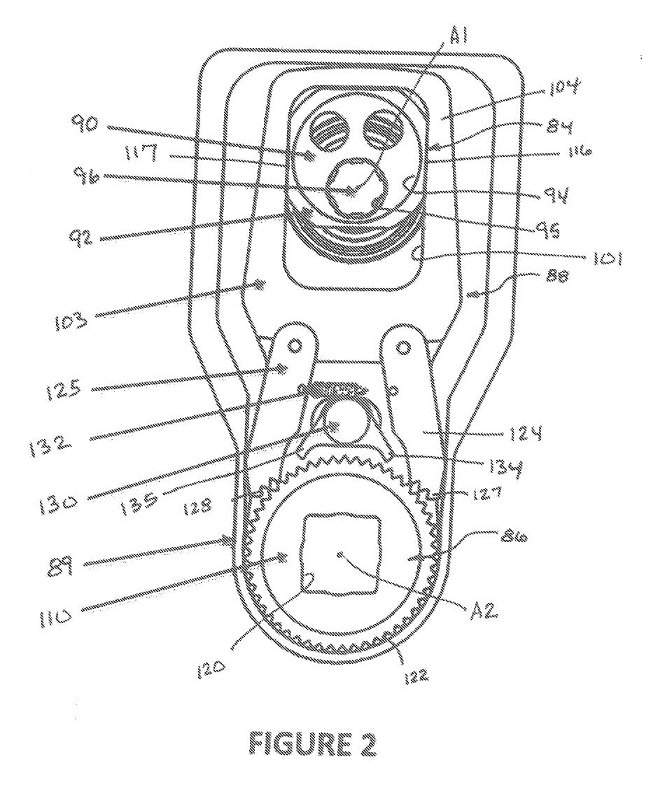

FIGS. 3a-3g illustrate the process of the driving mechanism through one cycle. FIG. 3a, shows where the first pawl 124 has pulled back for a push forward on the ratchet wheel 110. A first finger 134 of stop 130 engages a tooth 122 of ratchet wheel 110 to prevent reverse motion. As eccentric 90 reaches 60° of rotation (FIG. 3b), pawl 124 engages a new few teeth 122 for a further incremental rotation of wheel 110. A second finger 135 of cam 130 is positioned to lift the second pawl 125 from teeth 122. At 80° of eccentric rotation (FIG. 3c), pawl 124 pushes forward and moves ratchet wheel 1.6° of rotation. At 90° rotation of eccentric 90 (FIG. 3d), pawl 124 continues its forward movement to push ratchet wheel through 2.5° of rotation. At a 170° of rotation of eccentric 90 (FIG. 3e), pawl 124 has moved ratchet wheel through 7.2° of rotation whereupon first finger 134 engages a tooth 122 to prevent reverse movement of wheel 110. At 240° of rotation of eccentric 90 (FIG. 3f), pawl 124 is pulled back and disengaged from teeth 122 to, then, begin a second incremental rotation of ratchet wheel 110. At 320° of rotation of eccentric 90 (FIG. 3g), pawl 124 approaches ratchet wheel again to engage teeth 122 and rotate ratchet wheel 110. The process is the mirror image for pawl 125 to push ratchet wheel 110 in an opposite direction, i.e., when eccentric 90 is moved in the opposite direction.

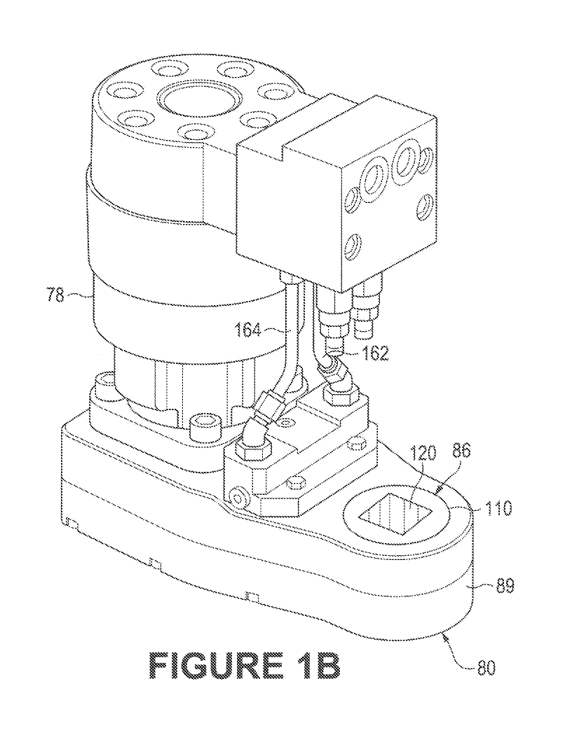

Stop 130 is adjustable between two positions; i.e., stop 130 operates to facilitate rotation of wheel 110 in one direction by pawl 124 when in a first position, and operates to facilitate rotation of wheel 110 in an opposite direction by pawl 125 when in a second position (FIGS. 2-3g). In a preferred construction, stop 130 is hydraulically adjusted between the two positions, but it could be adjusted by pneumatic, electric or otherwise arrangements. In each position, it is preferred that the stop prevent reverse motion of wheel 110 when the driving pawl is retracted, and prevent the non-driving pawl to contact wheel 110 during application of torque to pin 50 or other component. Nevertheless, these functions could be completed separately.

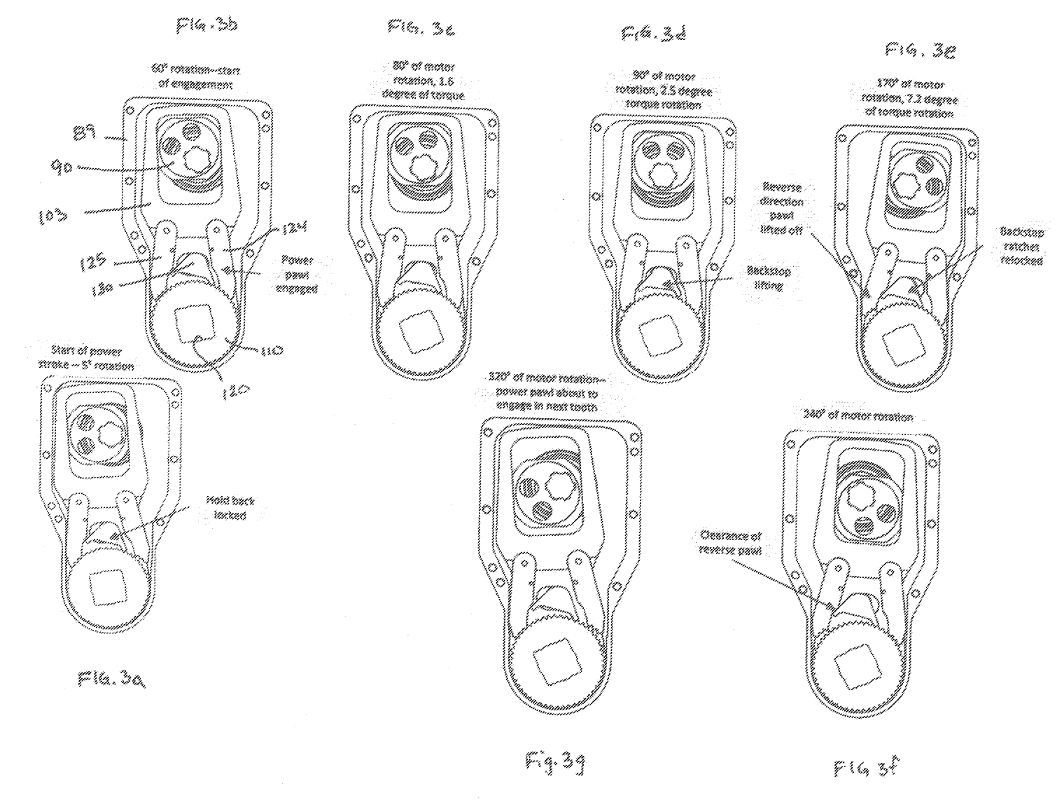

The stop 130 can be adjusted by the fluid (preferably hydraulic) driving motor 78. An adjustment assembly 132 is provided in torque head 80 to move stop 130 between its two positions (FIG. 4). In this example, adjustment assembly 132 includes a passage 142 closed on each end by a plug 144, 145. A pair of pistons 146, 147 joined by a piston rod 148 is set within the passage between plugs 144, 145. Pressure ports 151, 152 are in fluid communication with passage 142. One port 151 is coupled to passage 142 between piston 146 and plug 144, and one port 151 is coupled to passage 142 between piston 147 and plug 145. When the fluid flows in one direction it enters passage 142 through first port 151 to push piston 146 away from plug 144. The piston rod 148 then shifts piston 147 toward plug 145, and in so doing pushes fluid out of passage 142 and through port 152. When the fluid flows in the opposite direction, the piston assembly shifts in the opposite direction in passage 142. A shifting spool 155 is supported midway on piston rod 148 between the two pistons with a biasing spring 157, 158 between the spool and each piston. A lever or other connector 160 couples spool 155 and stop 130. As the pistons 146, 147 shift back and forth in passage 142, the spool 155 shifts and moves lever 160, which in turn, moves stop 130 between the two operation positions. Other adjustment assemblies could be used. The fluid run through adjustment assembly 132 is also preferably run through motor 78 such that the direction of flow is automatically consistent for a single direction of rotation for both the motor 78 and the adjustment assembly 132. Ducts 162, 164 direct fluid to adjustment assembly 132 (FIG. 1B).

With a hydraulically-driven motor 78 and stop 130, torque head 80 can be robust in varied environmental conditions, though other drives are possible for certain operations and/or conditions. A hydraulically-driven operation is less susceptible (e.g., as compared to electric drives) to failure in in-field operations where it may be subject to varied environmental conditions such as heat, cold, precipitation, dirt, fines, dust, smoke, corrosive materials, etc. A hydraulic drive is also able to provide substantial power by compact means (e.g., as compared to electric drives), which is useful for certain applications.

While the above discusses the use of torque head in replacing wear members in a mining environment, the torque head has many other and diverse applications. A torque head in accordance with the present invention may be useable to turn threaded and/or other rotative members where enhanced torque is required and desired.

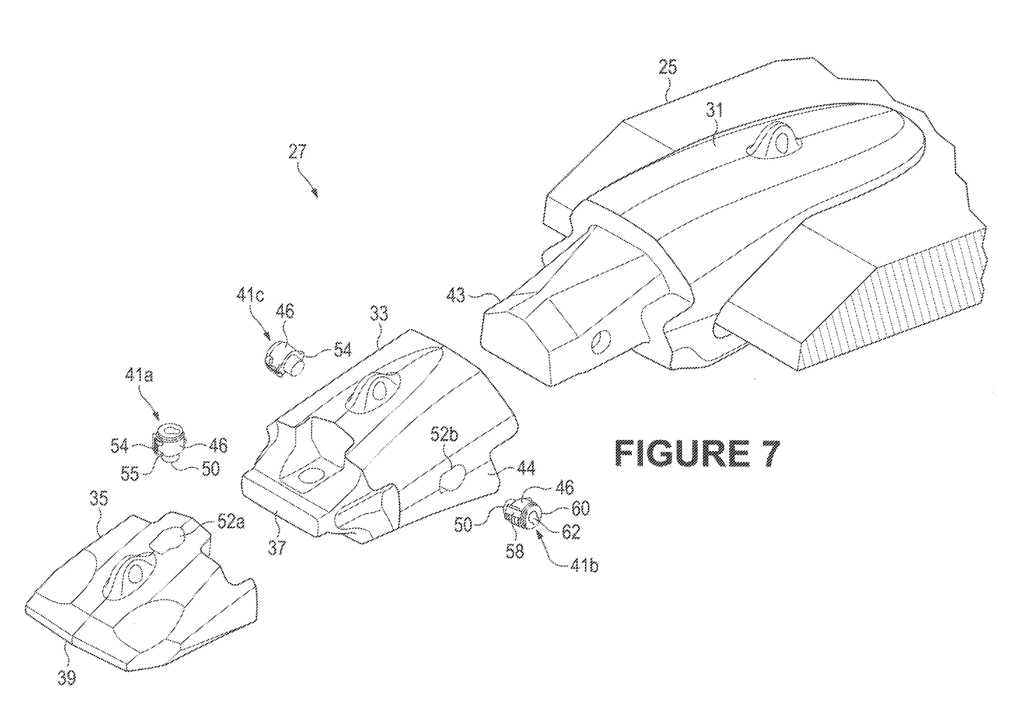

In another embodiment (FIG. 8), the digging edge can be defined by a stepped lip 200 in either a spade or reverse spade configuration. A stepped lip includes a series of step segments 202 that extend perpendicular to the direction of bucket travel when digging. The step segments 202 are spaced apart from each other laterally (i.e., across the bucket mouth), and offset in a rearward/forward direction (i.e., in and out of the bucket cavity) from adjacent step segments. The illustrated lip 200 has a spade configuration such that the central step segment 202a is the portion of the lip that projects farthest forward. Step segments 202b, 202c are spaced laterally and offset rearwardly relative to step segment 202a. In a spade lip configuration (not shown), the central step segment would be the portion that extends farthest rearward. Transition segments 204 interconnect adjacent step segments 202. As illustrated, transition segment 204a sets between step segments 202a, 202b, and transition segment 204b sets between step segments 202a, 202c. Transition segments 204 are inclined to the step segments 202 and to the direction of travel of the bucket. The angle of inclination a of transition segments 204 to step segments 202 can vary widely from lip to lip. As examples, angle of inclination for the transition segments in loaders and shovels are generally 17° or less, and in reverse spade lips for dragline it is generally between 8-10°. Nevertheless, inclinations outside these ranges are possible for these and other kinds of machines. The number of step and transition segments 202, 204 included will depend on the design and size of the lip.

In the illustrated example, teeth 210 and shrouds 212 are secured to lip 200 with the teeth mounted on step segments 202 and the shrouds mounted in between each tooth on step segments 202 and transition segments 204. In this embodiment, the teeth include adapters 214 secured to the lip, and points 216 mounted on the adapters. Locks 41 are secured in a hole (not shown) in sidewall 218 of each point 216. The shrouds 214 can crowd the locks 41 and make accessing them difficult, e.g., with a torque wrench or especially when using an auto removal/installation assembly such as discussed herein. While such auto assemblies are safer by removing the worker from the process, they are bulkier and can have difficulty gaining access to the locks. The limited clearance is exacerbated when the shroud is on a transition segment that projects outward from the sidewall 218 containing the lock 41. As one example, the shroud secured to transition segment 204b projects farther forward relative to the tooth secured to step segment 202c, i.e., as compared to a shroud on a straight lip or an oppositely inclined transition segment. With a two-part tooth system as shown in FIG. 8, the tooth components with the more severely limited clearance are on one side of the lip. With a three-part tooth system, intermediate adapters have locks in both sidewalls providing clearance difficulties for teeth on both sides of the central step segment. In some cases, the clearance is sufficiently limited to preclude the use of auto removal/installation assemblies without the use of torque head 80.

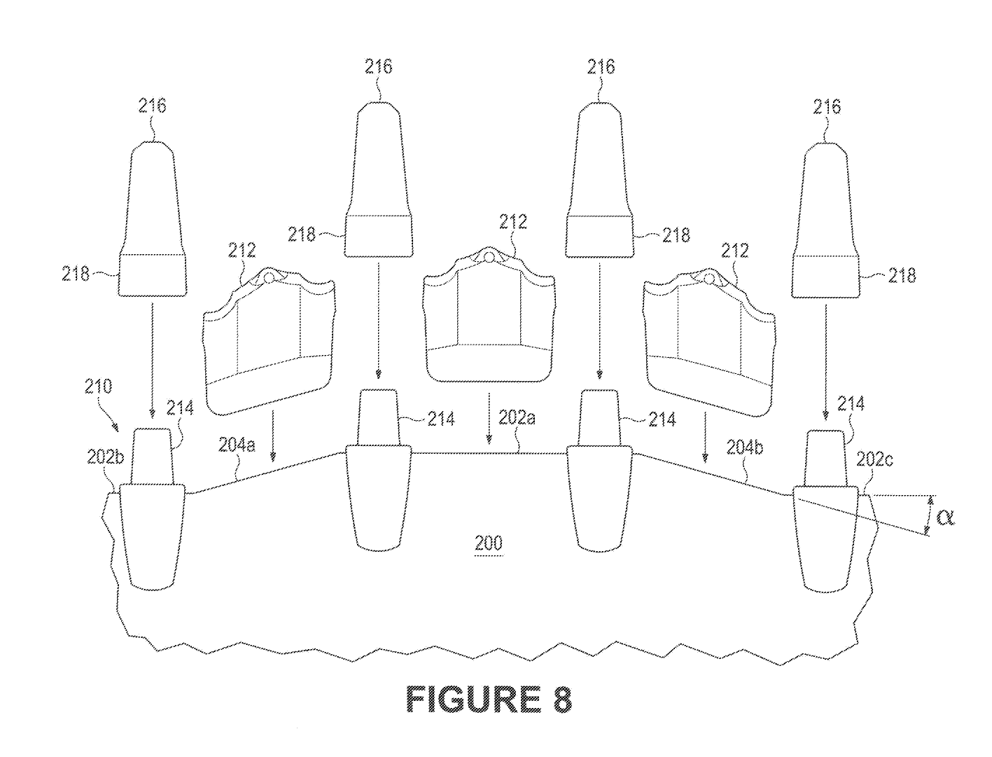

In one example (FIG. 9), a tool head 220 is adapted for removal and/or installation of an intermediate adapter 33. Tool head 220 includes a gripping assembly 222 to hold intermediate adapter 33, and a pair of torque tools 224 to adjust the pins 50 in the locks 41. As with torque tool 76 of tool head 70, torque tools 224 include a motor 78, a torque head 80, and a tool 82 for engaging the pins 50. In a preferred construction, torque head 80 is vertically oriented such that output portion 86 lies adjacent lock 41, and input portion 84 with motor 78 is spaced upward such that motor 78 overlies the adjacent shroud 212 without conflict. Alternatively, in some lip arrangements, torque heads 80 could be oriented horizontally with input portion 84 and motors 78 extending forward of the adjacent shrouds 212. Other orientations of torque head 80 are possible to provide sufficient clearance for motor 78. In one example, output portion 86 is thinner than the input portion 84, with thickness being in the direction the torque axes A1, A2 extend. In one other example, output portion 86 has a thickness of about 60 mm to fit within the clearance available to couple with locks 41 even in stepped lip environments. In another example, the thickness of output portion 84 can be about 25% of the combined thickness of input portion 84 and motor 78. Additionally, torque head 80 could be made longer or shorter if needed to provide adequate clearance.

In another embodiment, a torque applying apparatus 250 includes two torque heads with torque enhancing capabilities linked in series to apply increased torque and/or maintaining the torque with smaller components. The torque heads each provide an applied torque offset and parallel to a received torque, with the applied torque of the upstream torque head being the received torque for the downstream torque head. In one other example, the torque heads are linked as mirror images with the initiating driving torque aligned with the final applied torque. In another example, the torque heads are adjustably positioned relative to each other to accommodate different environments. The features of these examples are usable in combination or separately.

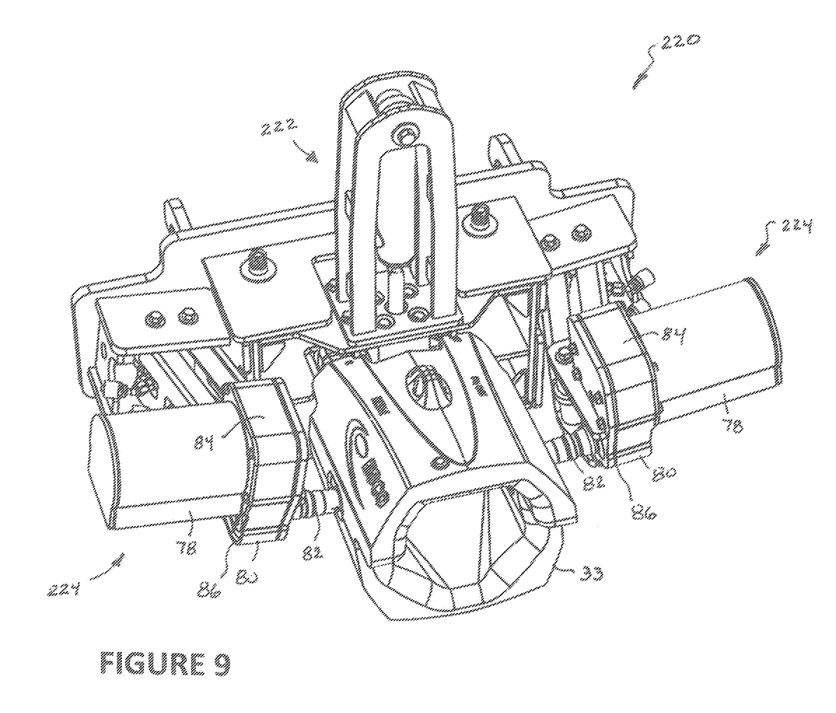

In one example (FIG. 10), torque applying apparatus 250 includes a first torque head 80A coupled in series with a second torque head 80B. Each torque head 80A, 80B has an input portion 84A, 84B and an output portion 86A, 86B, and a driving mechanism to apply enhanced torque from the input portion to the output portion that is the same as driving mechanism 88 as described above for torque head 80 (see FIG. 2). A motor 78 with a draft shaft couples to the eccentric in torque head 80A in the same way as described above for torque head 80. A rod 252 extends between output portion 86A and input portion 84B to provide the received torque to torque head 80B. A tool 82 is secured in the opening provided in output portion 86B to drive a threaded or other rotative component. In this way, the applied torque can be twice the applied torque for tool head 80 (e.g., with an enhancement of applied torque from tool head 80B to received torque from motor 78 of 24:1). Alternatively, the torque heads could be made smaller such that each torque head enhanced the received torque by, e.g., 6:1 for a total enhancement of 12:1 from motor 78. Smaller components may provide less overall weight making the apparatus more portable and easier to use by a worker outside of an auto assembly. The torque enhancements given above are simply examples and other torque enhancements are possible.

In torque applying apparatus 250, as shown in FIG. 10, the drive shaft of motor 78 is aligned with the tool coupled to output portion 86B. This arrangement may provide increased stability and ease of use by a worker. Nevertheless, in view of clearance or other concerns, torque head 80B could have a different orientation to torque head 80A. As one example, torque head 80B could be oriented 180° from the arrangement in FIG. 10 such that output portion 86B extends beyond output portion 86A. Alternatively, torque head 80B could be angled at nearly any angle to torque head 80A provided output portion 86A and input portion 84B are aligned and connected by rod 252. An assembly (not shown) could be included to permit adjustment of and hold torque head 80B to any desired angular position relative to torque head 80A.

While the above description primarily pertains to the installation, initiation and/or release of locks with threaded or rotative members in the process of removing and/or installing of wear parts, the disclosed processes and apparatus are not limited to this usage. In one example, the torque applying apparatus 80, 250 could be used with a rotative tool such as disclosed in U.S. Patent Application 2017/0356167 that is set at the rear end of a wear member to be removed so as to force the wear member from its base. This system may apply sufficient torque to push the wear member from the base even when resisted by impacted fines. The torque applying apparatus 80, 250 could be used with an auto assembly for removing/installing wear parts or separately as a tool operated by a worker.

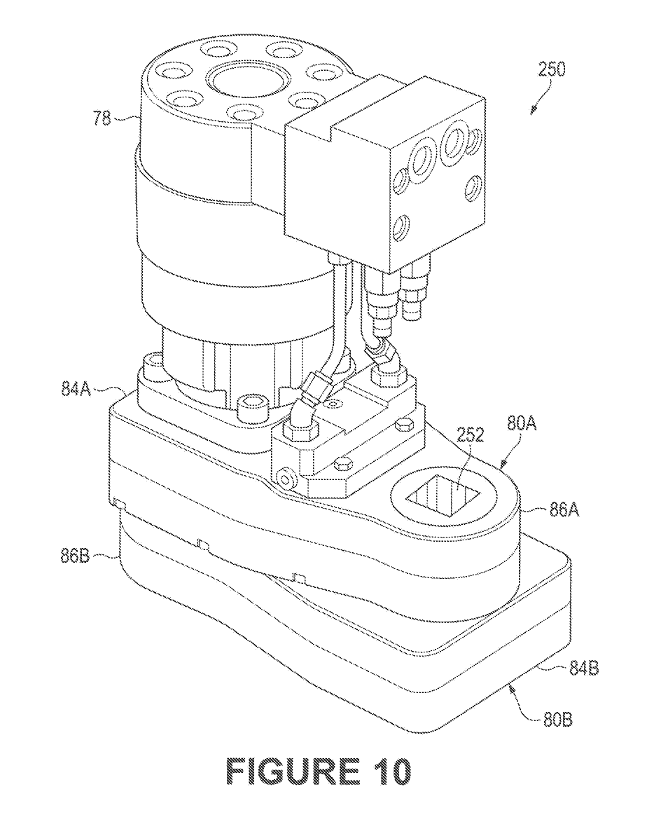

Torque applying apparatus 80, 250 could be used to tighten and/or loosen bolts 253 securing a blade 254 to a mold board 256 (FIG. 11). The mold board could be lifted from the ground without removing it from the earth working machine to provide sufficient clearance for the torque applying apparatus.

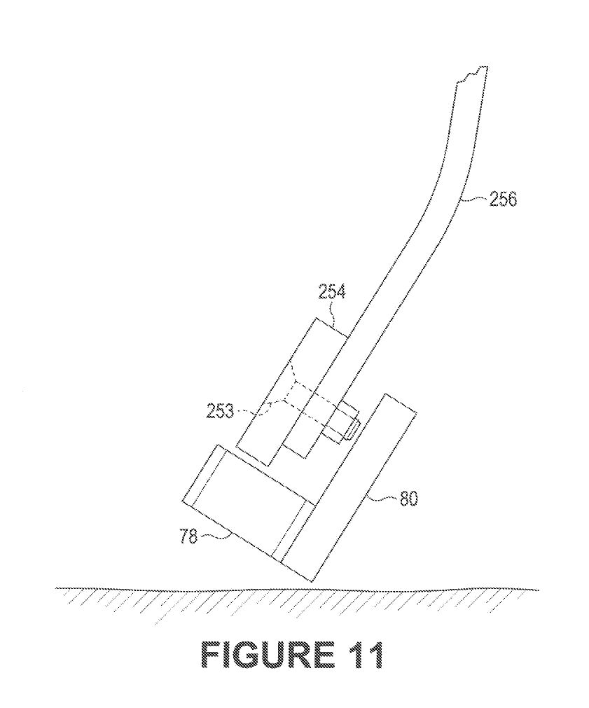

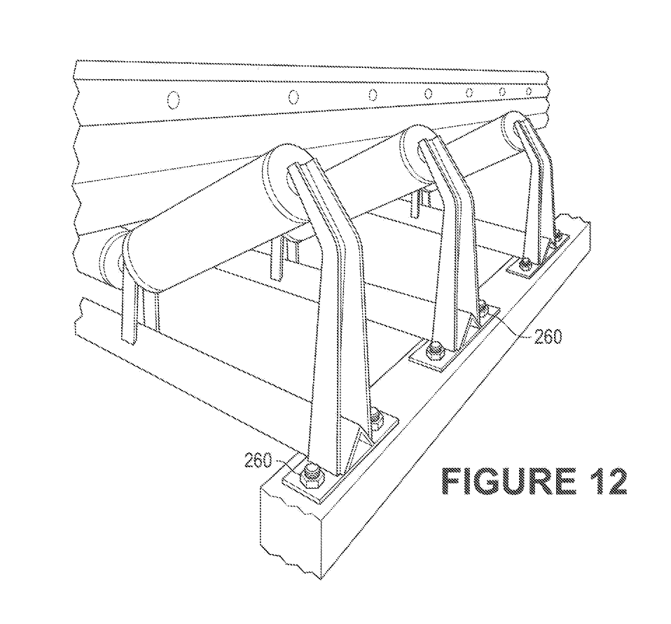

The torque applying apparatus 80, 250 could also be used to work on conveyor systems such as illustrated (as examples) in FIGS. 12 and 13. The torque applying apparatus could be used to loosen bolts such as bolt 260 (FIG. 12) or a bolt received into slot 262 (FIG. 13) or other bolts in the conveyor system. The torque applying apparatus may be used in a larger system to conduct maintenance on the conveyor system or used on its own.

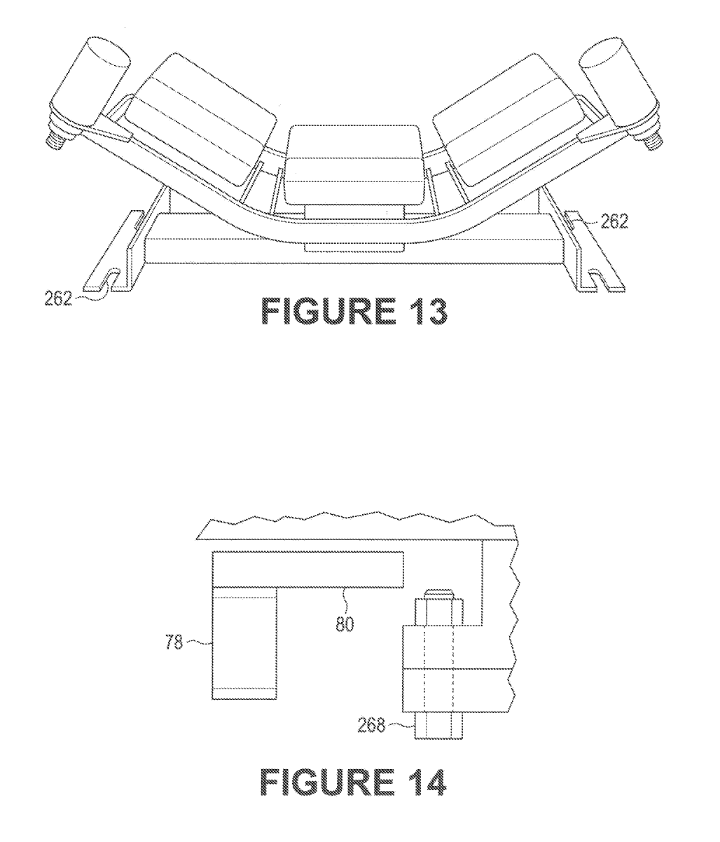

Torque applying apparatus 80, 250 could also be used to loosen bolts 268 placed tight quarters such as shown in FIG. 14. This is an example of a more general application. The processes and torque applying apparatuses in accordance with the invention may have other uses involving turning a threaded member or other rotative member that are not disclosed herein.

1. A torque applying apparatus including a hydraulically-driven power source that is adjustable for bi-directional rotation, an input portion receiving torque from the power source and having a first rotational axis, an output portion configured to provide torque to a rotating component and having a second rotational axis, the second rotational axis being parallel to and laterally offset from the first rotational axis, and a force-multiplying mechanism connecting the input portion to the output portion.

2. The torque applying apparatus of claim 1 wherein the output portion is thinner than the combined power source and input portion in the direction of the rotational axes.

3. The torque applying apparatus of claim 1 wherein the thickness of the output portion is less than or equal to about 60 mm.

4. The torque applying apparatus of claim 1 including a power source coupled to the input portion, wherein the output portion is about 25% or less of the combined thickness of the power source and input portion.

5. A system for applying torque to a rotating component comprising:
a power source; and
first and second torque applying apparatuses each including an input portion configured to receive torque and having a first rotational axis, an output portion configured to provide torque and having a second rotational axis, the second rotational axis being parallel to and laterally offset from the first rotational axis, and a force-multiplying mechanism connecting the input portion to the output portion;
wherein the power source is coupled to the input portion of the first torque applying apparatus, the output portion of the first torque applying apparatus is coupled to the input portion of the second torque applying apparatus, and the output portion of the second torque applying apparatus is coupled to the rotating component.

6. The system of claim 5 wherein the power source is hydraulically driven and adjustable for bi-directional rotation.

7. A system for removing wear parts secured to earth working equipment by a rotating a locking element, the system comprising:
a gripper to hold the wear part secured to earth working equipment by a rotatable locking element;
a power source; and
a torque applying apparatus including an input portion configured to receive torque from the power source and having a first rotational axis, an output portion configured to provide torque to the rotatable component and having a second rotational axis, the second rotational axis being parallel to and laterally offset from the first rotational axis, and a force-multiplying mechanism connecting the input portion and the output portion.

8. The system of claim 7 wherein the power source is coupled to the input portion, and the output portion is thinner than the combined power source and input portion in the direction of the rotational axes.

9. The system of claim 7 wherein the thickness of the output portion is less than or equal to about 60 mm.

10. The system of claim 7 wherein the output portion is about 25% or less of the combined thickness of the power source and input portion.

11. The system of claim 7 wherein the power source is hydraulically driven and adjustable for bi-directional rotation.

12. A system for applying torque to a rotatable component accessible through a space of limited access, the system comprising:
a hydraulically-driven power source that is adjustable for bi-directional rotation; and
a torque applying apparatus including an input portion configured to receive torque from the power source and having a first rotational axis, an output portion configured to provide torque to the rotatable component and having a second rotational axis, the second rotational axis being parallel to and laterally offset from the first rotational axis, and a force-multiplying mechanism connecting the input portion and the output portion.

13. The system of claim 12 wherein the output portion is thinner than the combined power source and input portion in the direction of the rotational axes.

14. The system of claim 12 wherein the thickness of the output portion is less than or equal to about 60 mm.

15. The system of claim 12 wherein the output portion is about 25% or less of the combined thickness of the power source and input portion.

16. A process for removing wear parts secured to earth working equipment by a rotating a locking element, the process comprising:
holding the wear part secured to earth working equipment by a rotatable locking element with a gripper secured to a manipulator;
coupling a torque applying apparatus to the rotatable locking element wherein the torque applying apparatus includes an input portion having a first rotational axis, an output portion having a second rotational axis that is parallel to and laterally offset from the first rotational axis, and a force-multiplying mechanism connecting the input portion and the output portion;
supplying torque to the input portion to move the locking element to a release position; and
removing the wear part from the earth working equipment with the gripper and manipulator after the locking element is moved to the release position.

17. The process of claim 16 wherein the torque is supplied to the input portion by a hydraulically-driven power source that is adjustable for bi-directional rotation.

18. A process for applying torque to a rotatable component accessible through a space of limited access, the system comprising:
using a torque applying apparatus including an input portion having a first rotational axis, an output portion having a second rotational axis that is parallel to and laterally offset from the first rotational axis, and a force-multiplying mechanism connecting the input portion and the output portion;
passing the output portion through the space of limited access and coupling the output portion to the rotatable component; and
supplying torque to the input portion to rotate the rotatable component.

19. The process of claim 18 wherein the torque is supplied to the input portion by a hydraulically-driven power source that is adjustable for bi-directional rotation.

20. The process of claim 19 wherein the rotatable component is securing an in-field component in a mine.
